(19) United States
(12) Patent Application Publication
(10) Pub. No.: US 2002/0085674 A1
(43) Pub. Date: Jul. 4, 2002

(54) Radiography device with flat panel X-ray source

(76) Inventors: John Scott Price, Wauwatosa, WI (US); Bruce M. Dunham, Mequon, WI (US); Colin R. Wilson, Niskayuna, NY (US)

Correspondence Address: Kevin G. Mierzwa, ARTZ & ARTZ, P.C., Suite 250, 28333 Telegraph Road, Southfield, MI, 48034, US

(21) Appl. No.: 09/751,210

(22) Filed: Dec. 29, 2000

(51) Int. Cl. H01J 35/00

(52) U.S. Cl. 378/122; 378/136; 378/143

(57) ABSTRACT

A radiography system (10) has a solid state x-ray source that includes a substrate with a cathode (58) disposed thereon within a vacuum chamber (52). An anode (68) is spaced apart from cathode within vacuum chamber (52). The system may include a computer (36) that controls an x-ray controller (28) and a plurality of detectors elements (20) which provide data acquisition system (32) with predetermined data in response to x-ray submitted at x-ray source (14). Data acquisition system (32) is used in image reconstructor (34) to provide the desired image. An interface (48) may be used to transmit the image to a remote diagnostic facility. The wireless interface (48) is particularly suitable for communication with a remote diagnostic facility.

### TECHNICAL FIELD

The present invention relates generally to a radiography device and, more particularly, to a radiography device having a flat panel X-ray source.

### BACKGROUND ART

In at least some computed tomograph (CT) imaging system configurations, an x-ray source projects a fan-shaped beam which is collimated to lie within an X-Y plane of a Cartesian coordinate system and generally referred to as the “imaging plane”. The x-ray beam passes through the object being imaged, such as a patient. The beam, after being attenuated by the object, impinges upon an array of radiation detectors. The intensity of the attenuated beam radiation received at the detector array is dependent upon the attenuation of the x-ray beam by the object. Each detector element of the array produces a separate electrical signal that is a measurement of the beam attenuation at the detector location. The attenuation measurements from all the detectors are acquired separately to produce a transmission profile.

In known third generation CT systems, the x-ray source and the detector array are rotated with a gantry within the imaging plane and around the object to be imaged so that the angle at which the x-ray beam intersects the object constantly changes. X-ray sources typically include x-ray tubes, which emit the x-ray beam at a focal spot. X-ray detectors typically include a collimator for collimating x-ray beams received at the detector. A scintillator is located adjacent the collimator, and photodiodes are positioned adjacent the scintillator.

Multislice CT systems are used to obtain data for an increased number of slices during a scan. Known multislice systems typically include detectors generally known as 3-D detectors. With such 3-D detectors, a plurality of detector elements form separate channels arranged in columns and rows. Each row of detectors forms a separate slice. For example, a two slice detector has two rows of detector elements, and a four slice detector has four rows of detector elements. During a multislice scan, multiple rows of detector cells are simultaneously impinged by the x-ray beam, and therefore data for several slices is obtained.

A system that does not require a rotating x-ray source is described in U.S. Pat. Nos. 4,521,900 and 4,521,901. In the '900 patent, a large vacuum chamber is used which incorporates an electron gun and ring-shaped targets to produce x-rays. The electron beam emerges from the gun several feet away from the patient, travels a bent path to move toward the targets then hits the material to produce x-rays. The single fairly high power electron beam sweeps out a circle, a ring that surrounds the patient, to produce the “scan” effect. One drawback to such a system is that a large vacuum system to enclose the electron beam's path or trajectory is required. Further, a complicated beam deflection system is employed to accurately steer the beam.

Accordingly, it would be desirable to provide a CT scanner and CT scanner system that provides a x-ray source that reduces the complexity of the scanning system and does not require a rotating x-ray source.

### SUMMARY OF THE INVENTION

One object of the invention is to provide an improved x-ray source having a stationary anode.

In one aspect of the invention, a radiography system has a solid state x-ray source that includes a substrate with a cathode disposed thereon within a vacuum chamber. An anode is spaced apart from cathode within vacuum chamber. The system may include a computer that controls an x-ray controller and a plurality of detectors elements which provide data acquisition system with predetermined data in response to x-ray submitted at x-ray source. Data acquisition system is used in image reconstruction to provide the desired image. An interface may be used to transmit the image to a remote diagnostic facility. The interface is particularly suitable for communication with a remote diagnostic facility.

Other objects and advantages of the present invention will become apparent upon the following detailed description and appended claims, and upon reference to the accompanying drawings.

### BRIEF DESCRIPTION OF THE DRAWINGS

FIG. 1 is a pictorial view of a CT imaging system according to the present invention.

FIG. 2 is a block schematic diagram of the system illustrated in FIG. 1.

FIG. 3 is a lateral cross-sectional view of a solid state x-ray tube according to the present invention.

FIG. 4 is a longitudinal cross-sectional view of a solid state x-ray tube according to the present invention.

### DETAILED DESCRIPTION OF THE PREFERRED EMBODIMENT

In the following figures, the same reference numerals are used to identify the same components. The present invention is described with respect to a computed tomograph system. However, the present invention may be applied to other radiography procedures such as mammography and vascular imaging. The present invention is particularly suitable for enabling portability of radiography devices such as enabling portable X-ray machines.

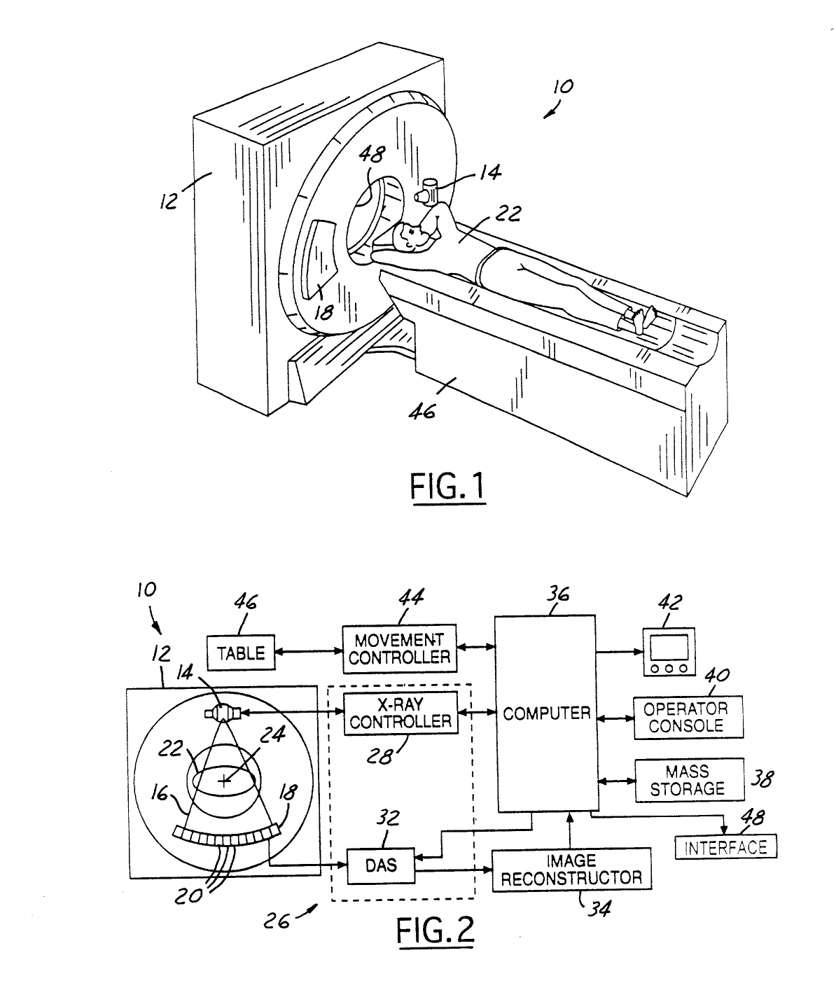

Referring to FIG. 1, a radiography system 10 such as a computed tomography (CT) imaging system which is shown as including a gantry 12 representative of a “third generation” CT scanner. The gantry 12 has an x-ray source 14 that projects a beam of x-rays 16 toward a detector array 18 on the opposite side of the gantry 12.

The detector array 18 is formed by a plurality of detection elements 20 which together sense the projected x-rays that pass through a medical patient 22. Each detection element 20 produces an electrical signal (detector output signal) that represents the intensity of an impinging x-ray beam and hence, the attenuation of the beam as it passes through the patient 22. During a scan to acquire x-ray projection data, the housing 12 and the components mounted thereon rotate about a center of gravity.

The operation of the x-ray source 14 is governed by a control mechanism 26 of the CT system 10. The control mechanism 26 includes an x-ray controller 28 that provides power and timing signals to the x-ray source 14. A data acquisition system (DAS) 32 in the control mechanism 26 samples analog data from the detection elements 20 and converts the data to digital signals for subsequent processing. An image reconstructor 34 receives sampled and digitized x-ray data from the DAS 32 and performs high speed image reconstruction. The reconstructed image is applied as an input to a computer 36 which stores the image in a mass storage device 38.

The computer 36 also receives and supplies signals via a user interface or graphical user interface (GUI). Specifically, the computer 36 receives commands and scanning parameters from an operator console 40 that preferably includes a keyboard and mouse (not shown). An associated cathode ray tube display 42 allows the operator to observe the reconstructed image and other data from the computer 36. The operator supplied commands and parameters are used by the computer 36 to provide control signals and information to the x-ray controller 28, the DAS 32, and a movement controller 44 such as a table controller in communication with a table 46 to control operation of and movement of the system components. Movement controller 44 may also be configured to move the X-ray source relative to patient in a linear manner which is further described below.

Those skilled in the art will recognize the various radiography devices that the present invention may be employed upon may contain more or less of the components illustrated in FIG. 2. For example, a CT system would employ the table motor controller 44. A portable x-ray device may not include a table motor controller 44, for it may not be desirable to move a patient into and out of the machine automatically.

In addition to the above components, an interface 48 may be coupled to computer 36. Interface 48 may be one of a variety of communication interface devices. For example, interface 48 may be a telephony interface or a wireless communication interface for use over the wireless telephone system. The interface 48 is used for remote diagnostic purposes. For example, interface 48 may couple the system to the Internet to provide an expert with a predetermined image. A wireless interface would be particularly useful for a portable x-ray device. Such portable x-ray devices may be in use in remote locations or mobile locations such as ambulances.

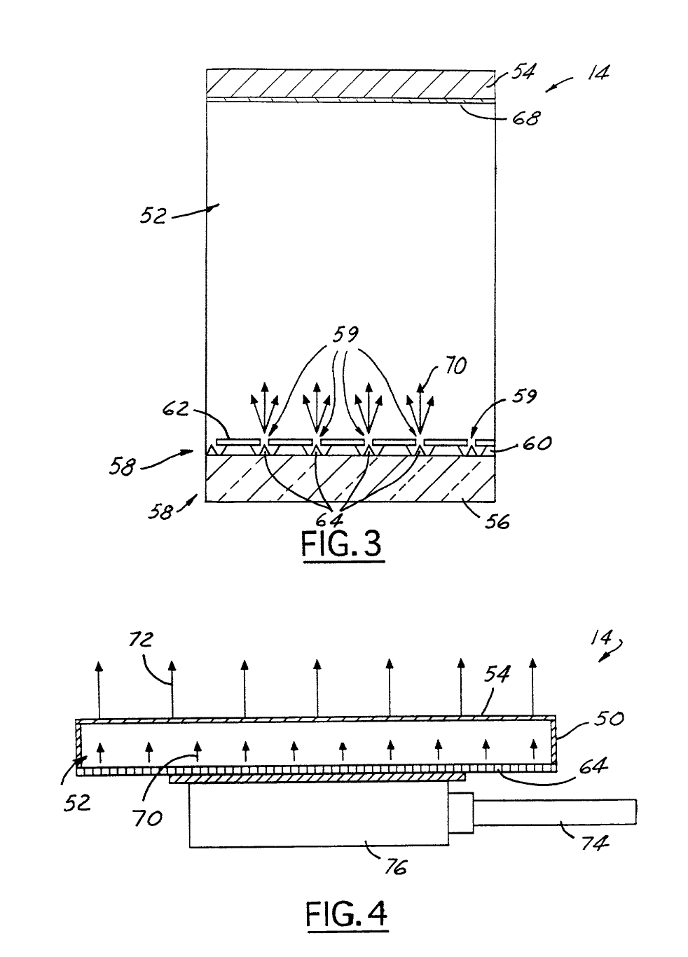

Referring now to FIGS. 3 and 4, a respective lateral and longitudinal cross-sectional view of an x-ray source 14 is illustrated. X-ray source 14 has a housing 50 therearound. Housing 50 is structured to provide a vacuum chamber 52 therein. Preferably, housing 50 hermetically seals vacuum chamber 52. Housing 50 may be constructed of a number of materials or combinations of materials. Preferably, housing 50 has a layer or material that prevents x-ray transmission therethrough. An x-ray transmissive window 54 is provided through housing 50 and allows for the transmission of x-rays therethrough. Various materials may be used to form x-ray transmissive window 54. X-ray transmissive material is preferably a low atomic weight material such as carbon or beryllium. An example of a suitable x-ray transmissive window is graphite. Graphite is desirable because of its ability to absorb electrons and its heat storage and heat conductivity.

A substrate 56 such as a silicon substrate is positioned within housing 50. Substrate 56 may also form a portion of housing 50. Substrate 56 may be doped to form a portion of a cathode 58. The cathode 58 is formed of a plurality of cathode emitters 59. Substrate 56 may have an insulating layer 60, a cathode film 62, and a plurality of cones 64. Insulating layer 60 may be discontinuous, i.e., with spaces therebetween. Cones 64 may, for example, be molybdenum cones that are used to generate the electrons. The cones 64 may be disposed with the spaces between the insulating layer so that the cones 64 directly contact substrate 56. Cathode film 62 may also be formed from molybdenum. Of course, those skilled in the art will recognize other types of solid state emitters including thin film field emission cathodes and photo emitters such as those of the laser induced photo emission category. In a photo emission device such as a laser device, emission occurs according to the order in which laser beams of sufficient power and proper wavelength address the cathode structure by scanning across the face of the flat panel plane.

An anode 68 is disposed upon x-ray transmissive window 54. Anode 68 attracts the electrons generated at cathode 58 thereto. Anode 68 is preferably a thin film anode and may be formed of a variety of materials. Suitable materials for anode 68 include tungsten or uranium. Preferably, anode 68 is formed of a high atomic weight material but a tradeoff may be made between the physical dimension, strength-to-weight ratio, and x-ray production and other thermal properties such as heat conductivity. Electrons impinging upon anode 68 will generate x-rays which leave the x-ray source 14 through an x-ray transmissive window 54. Of course, in practice, no anode 68 is entirely perfect and therefore some electrons may pass through the thin film anode 68 and into x-ray transmissive window 54. The desirability of an electrically transmissive and thermally transmissive material for x-ray transmissive window is a consequence thereof. When an electron passes through anode 68, x-ray transmissive window 54 absorbs it electrically and dissipates any heat from anode 68 or from the electron passing through anode 68. The electrons are illustrated as lines 70 in FIG. 4 and the x-rays are illustrated as line 72.

X-ray source 14 may be coupled to a high voltage cable 74 and an insulator 76. The individual emitters are controlled through x-ray controller 28 and in response to high voltage from high voltage controller 74 generate electrons.

Cathode emitters 59 may be disposed in a linear array or a two-dimensional array. In operation, x-ray controller 28 moves the x-ray beam in the desired manner. Preferably, each of the cathode emitters 59 are addressable if a scanning beam is required in which certain emitters are energized at certain times to generate the electrons. In practice, the cathode emitters 59 may also be simultaneously energized over the entire array. A linear cathode array may be suitable for use if a moveable housing is employed. The computer 36 may control the movement of the housing relative to the patient in a manner longitudinal to the patient similar to that of a photocopier. The portion of the body is then “scanned.” Once the data acquisition system 32 acquires the data from the detectors, image reconstructor 34 may construct the image on computer 36 and display it through display 42. Also, the image may also be transmitted, as described above, through interface 48. As those skilled in the art will recognize, by using a stationary anode, i.e., which is not rotating, the complexity and therefore the cost is substantially reduced. That is, no bearing, rotor and motor for drive rotation is required. No Z-axis growth, bearing wear, and balancing problems normally associated with traditional x-ray tubes are manifested in such a device.

While the invention has been described in connection with one or more embodiments, it should be understood that the invention is not limited to those embodiments. On the contrary, the invention is intended to cover all alternatives, modifications, and equivalents, as may be included within the spirit and scope of the appended claims.

In the claims:

1. An X-ray source assembly comprising:
a vacuum housing;
a cold cathode emitter disposed within said housing;
an X-ray transmissive window; and
a stationary anode layer disposed on said window spaced apart from said emitter, said anode comprised of a thin metallic film.

2. An X-ray source assembly as recited in claim 1 further comprising a substrate.

3. An X-ray source assembly as recited in claim 1 further comprising an insulative layer formed on said substrate, a thin film disposed on said insulative layer and an emitter cone disposed on said substrate, said cathode emitter disposed on said substrate.

4. An X-ray source assembly as recited in claim 1 wherein said X-ray transmissive window is composed of a carbon-based material.

5. An X-ray source assembly as recited in claim 1 wherein said X-ray transmissive window is electrically conductive.

6. An X-ray source assembly as recited in claim 1 wherein said cathode emitter comprises a plurality of photo emitters.

7. An X-ray source assembly as recited in claim 1 wherein said cold cathode emitter comprises a plurality of laser diodes.

8. An X-ray source assembly as recited in claim 1 wherein said cathode emitter comprises a monolithic semiconductor.

9. An X-ray source assembly as recited in claim 1 wherein said cathode emitter comprises a plurality of addressable emitter elements.

10. An X-ray source assembly as recited in claim 1 wherein said vacuum housing is hermetically sealed.

11. An X-ray source assembly as recited in claim 1 wherein said anode layer is selected from the group of uranium, tungsten and aluminum.

12. An X-ray source assembly as recited in claim 1 wherein said cold cathode is linearly distributed within said housing.

13. An X-ray source assembly as recited in claim 1 wherein said cold cathode is two dimensionally distributed within said housing.

14. An X-ray source assembly as recited in claim 1 further comprising a shielding layer disposed about said housing.

15. An X-ray source assembly comprising:
a vacuum housing;
a substrate disposed within said housing;
a plurality of cathode emitter elements disposed on said substrate;
an X-ray transmissive window; and
a stationary anode layer disposed on said window spaced apart from said emitter, said anode comprised of a thin metallic film.

16. An X-ray source assembly as recited in claim 15 further comprising a high voltage input coupled to said plurality of cathode emitter elements through said substrate.

17. An X-ray source assembly as recited in claim 15 wherein said plurality of cathode emitter elements comprise a molybdenum gate film.

18. An X-ray source assembly as recited in claim 15 wherein said X-ray transmissive window is electrically conductive.

19. An X-ray source assembly as recited in claim 15 wherein said X-ray transmissive window is electrically coupled to said cooling block.

20. An X-ray source assembly as recited in claim 15 wherein said cathode emitter comprises a plurality of addressable emitter elements.

21. A radiography device comprising:
a solid state X-ray source;
a detector generating a detector output signal;
an X-ray controller;
a data acquisition system receiving data output signal;
an image reconstructor coupled to said data acquisition system and generating an image signal in response to said data output signal;
a computer controlling the operation of said solid state x-ray source, said x-ray controller, said data acquisition and said image reconstructor; and
an interface coupled to said computer for transmitting said image signal.

22. A radiography device as recited in claim 21 wherein said X-ray source comprises:
a vacuum housing;
a cold cathode emitter disposed within said housing;
an X-ray transmissive window; and
a stationary anode layer disposed on said window spaced apart from said emitter, said anode comprised of a thin metallic film.

23. A radiography device as recited in claim 21 wherein said X-ray source is replaceable.

24. A radiography device as recited in claim 21 wherein said interface comprises a wireless interface.

25. A radiography device as recited in claim 21 wherein said interface comprises a telephony interface.

26. A radiography device as recited in claim 21 wherein said X-ray transmissive window is electrically conductive.

27. A radiography device as recited in claim 21 wherein said cathode emitter comprises a plurality of addressable emitter elements.
